(19) United States
(12) Patent Application Publication
(10) Pub. No.: US 2020/0234207 A1
(43) Pub. Date: Jul. 23, 2020

(54) MANAGEMENT SUPPORT SYSTEM AND METHOD

(71) Applicant: Hitachi, Ltd., Tokyo (JP)

(72) Inventors: Takuya MOGAWA, Tokyo (JP); Kazuaki TOKUNAGA, Tokyo (JP); Toshiyuki UKAI, Tokyo (JP); Yasuharu NAMBA, Tokyo (JP)

(21) Appl. No.: 16/558,437

(22) Filed: Sep. 3, 2019

(30) Foreign Application Priority Data
Jan. 18, 2019 (JP) 2019-007234

(51) Int. Cl. G06Q 10/06; G06Q 30/02

(52) U.S. Cl. CPC G06Q 10/0637; G06Q 30/0201

(57) ABSTRACT

Provided is a technique that enables a measure for guiding a target from a base state to a target state to be determined without having a human being define a target and a state transition opportunity. A management support system performs a transition opportunity calculation process that is a process including calculating one or a plurality of state transition opportunities from a base state to a target state with respect to M-number of targets (where M is a natural number such that M 2) on the basis of management data including data related to histories of the M-number of targets, and outputs output information including information related to the one or a plurality of state transition opportunities calculated in the transition opportunity calculation process.

### CROSS-REFERENCE TO PRIOR APPLICATION

This application relates to and claims the benefit of priority from Japanese Patent Application number 2019-007234, filed on Jan. 18, 2019 the entire disclosure of which is incorporated herein by reference.

### BACKGROUND

The present invention generally relates to support for management such as support for marketing.

An example of support for management is support for marketing. Examples of support for marketing include leading a customer to an opportunity suitable for guiding the customer to a target state in order to improve a return on investment (ROI) of a measure. For example, techniques disclosed in PLT 1 and PLT 2 may conceivably be used in marketing support.

### PLT 1: Japanese Patent Application Laid-open No. 2013-033363

### PLT 2: Japanese Patent Application Laid-open No. 2010-123027

### SUMMARY

As another example of marketing support, a customer journey map can conceivably be generated.

However, when generating a customer journey map, a journey (an example of a state transition opportunity) and a persona (an example of a target) are assumed by a marketer (a human being). For this reason, at least one of the following problems arises.
There is no way to verify the presence or absence or the effectiveness of a journey beyond the scope of the assumption made by the marketer.
While a journey may change or a journey without reproducibility may occur with changes in the market, since journeys are fixed, the marketer must re-assume a journey.

While such problems may also arise in management support other than marketing support, the techniques disclosed in both PLT 1 and PLT 2 cannot be used to solve the problems.

A management support system performs a transition opportunity calculation process that is a process including calculating one or a plurality of state transition opportunities from a base state to a target state with respect to M-number of targets (where M is a natural number such that M≥2) on the basis of management data including data related to histories of the M-number of targets, and outputs output information including information related to the one or a plurality of state transition opportunities calculated in the transition opportunity calculation process.

A measure for guiding a target from a base state to a target state without having a human being define a target and a state transition opportunity can be determined.

### BRIEF DESCRIPTION OF THE DRAWINGS

FIG. 1 shows an outline of an embodiment;

FIG. 2 shows a configuration of a marketing support system;

FIG. 3 shows a configuration of a purchase history table;

FIG. 4 shows a configuration of a customer table;

FIG. 5 shows a configuration of a customer class table;

FIG. 6 shows a configuration of a class history table;

FIG. 7 shows a configuration of a product table;

FIG. 8 shows a configuration of a store table;

FIG. 9 shows a configuration of an outside weather table;

FIG. 10 shows a configuration of a measure performance table;

FIG. 11 shows a configuration of a time-series feature amount table;

FIG. 12 shows a configuration of a diagram table;

FIG. 13 shows a configuration of a construction result table;

FIG. 14 shows an expression of a first kind of a transition diagram with a diagram ID “100”;

FIG. 15 shows an expression of a second kind of the transition diagram with the diagram ID “100”;

FIG. 16 shows an opportunity list as an example of output information;

FIG. 17 shows a flow of a marketing support process;

FIG. 18 shows an example of details of S1701;

FIG. 19 shows an example of details of S1702;

FIG. 20 shows an example of details of S1703;

FIG. 21 shows a part of an example of details of S1704;

FIG. 22 shows a part of an example of details of S1704;

FIG. 23 shows a part of an example of details of S1704; and

FIG. 24 shows an example of details of S1705.

### DESCRIPTION OF EMBODIMENTS

In the following description, an “interface apparatus” may be one or more interface devices. The one or more interface devices may be at least one of the following.
One or more Input/Output (I/O) interface devices. An Input/Output (I/O) interface device is an interface device with respect to at least one of an I/O device and a remote display computer. An I/O interface device with respect to a display computer may be a communication interface device. The at least one I/O device may be any of a user interface device such as an input device including a keyboard and a pointing device and an output device such as a display device.
One or more communication interface devices. The one or more communication interface devices may be one or more communication interface devices of a same kind (for example, one or more network interface cards (NICs)) or two or more communication interface devices of different kinds (for example, an NIC and a host bus adapter (HBA)).

In addition, in the following description, a “memory” is a memory that differs from an NVM in an NVM drive and is one or more memory devices, and may typically be a main storage device. The one or more memory devices in a memory may be volatile memory devices or non-volatile memory devices.

Furthermore, in the following description, a “persistent storage apparatus” is one or more persistent storage devices. A persistent storage device is, typically, a non-volatile storage device (for example, an auxiliary storage device) and may specifically be, for example, a hard disk drive (HDD) or a solid state drive (SSD).

In addition, in the following description, a “storage apparatus” may be at least a memory among a memory and a persistent storage apparatus.

Furthermore, in the following description, a “processor” is one or more processor devices. While at least one processor device is typically a microprocessor device such as a central processing unit (CPU), the processor device may be a processor device of a different kind such as a graphics processing unit (GPU). The at least one processor device may be single-core or multi-core. The at least one processor device may be a processor core. The at least one processor device may be a processor device in a broad sense of the term such as a hardware circuit (for example, a field-programmable gate array (FPGA) or an application specific integrated circuit (ASIC)) which performs a part of or all of processing.

In addition, although information that enables an output to be obtained in response to an input will be described below using expressions such as an “xxx table”, the information may be data of any structure or may be a machine learning model such as a neural network that generates an output with respect to an input. Therefore, an “xxx table” can be referred to as “xxx information”. In addition, in the following description, the configuration of each table is merely an example and a single table may be divided into two or more tables or all of or a part of two or more tables may constitute a single table.

Furthermore, in the following description, while a function will be described using expressions such as a “kkk portion”, a function may be realized when one or more computer programs are executed by a processor or may be realized by one or more hardware circuits (for example, an FPGA or an ASIC). In a case where a function is realized when a program is executed by a processor, since a prescribed process is performed while using a storage unit and/or an interface unit or the like as appropriate, the function may be considered at least a part of the processor. A process described using a function as a subject may be considered a process performed by a processor or an apparatus including the processor. A program may be installed from a program source. For example, the program source may be a program distribution computer or a computer-readable recording medium (for example, a non-transitory recording medium). The description of each function is merely an example and a plurality of functions may be consolidated into a single function or a single function may be divided into a plurality of functions.

In addition, in the following description, a “management support system” may be one or more physical computers or may be a software-defined system that is realized when at least one physical computer executes prescribed software. For example, when a computer has a display device and the computer displays information on its own display device, the computer may be a management support system. Alternatively, for example, when a first computer (for example, a server) transmits output information to a remote second computer (a display computer (for example, a client)) and the display computer displays the information (when the first computer displays information on the second computer), at least the first computer among the first computer and the second computer may be a management support system. In other words, the management support system “displaying output information” may refer to displaying output information on a display device included in a computer or a computer transmitting output information to a display computer (in the case of the latter, output information is to be displayed by the display computer).

Furthermore, in the following description, an “ID” of an element is identification information that may be expressed by alphanumeric characters or the like or may include, instead of or in addition to alphanumeric characters, a name of the element.

In addition, in the following description, while a unit of a time point is year, month and day or year, month, day, hour, minute, and second, the unit of a time point may be defined more broadly or finely.

Furthermore, in the following description, a common portion among reference characters may be used when describing elements of a same kind without distinction but reference characters may be used when describing elements of a same kind while distinguishing the elements from one another.

Hereinafter, an embodiment of the present invention will be described with reference to the drawings. In the present embodiment, a “target” is a “customer”, a “target attribute” is a “class”, and “management support” is “marketing support”. In addition, a “state” means that a prescribed feature amount related to a history of a customer (for example, a purchase amount) is stable. A state between a base state and a target state can be referred to as an “intermediate state”. A “state transition opportunity” is an opportunity for making a transition from a state to a next state.

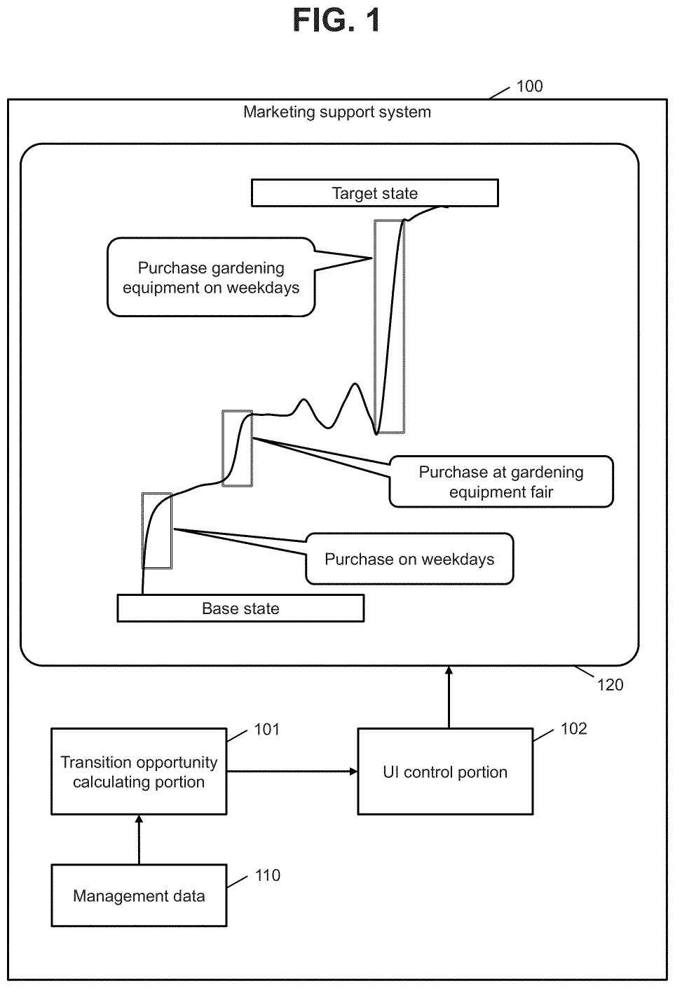

FIG. 1 shows an outline of the present embodiment.

A marketing support system 100 has a transition opportunity calculating portion 101 and a user interface (UI) control portion 102.

The transition opportunity calculating portion 101 performs, on the basis of management data 110 including data related to histories of a plurality of customers, a transition opportunity calculation process that is a process including calculating one or a plurality of state transition opportunities from a base state to a target state with respect to the plurality of customers.

The UI control portion 102 (an example of a result output portion) outputs output information 120 including information related to the one or a plurality of state transition opportunities calculated in the transition opportunity calculation process. An example of the output information 120 is a transition diagram such as that illustrated in FIG. 1 or, in other words, a transition diagram indicating one or a plurality of calculated state transition opportunities from a base state to a target state. The output information 120 such as a transition diagram is typically displayed on a graphical user interface (GUI) provided by the UI control portion 102. According to the transition diagram, the target state is realized through a plurality of state transition opportunities including “purchase on weekdays”, “purchase at gardening equipment fair”, and “purchase gardening equipment on weekdays”.

In this manner, in the present embodiment, one or a plurality of state transition opportunities are obtained from the management data 110 including data related to the histories of a plurality of customers. In other words, one or a plurality of state transition opportunities are obtained without having to define customer details and state transition opportunities. In addition, by looking at the output information 120 indicating the one or a plurality of state transition opportunities, a user (for example, a marketer) can determine a measure to be implemented on the basis of a relationship between a state of a customer and the state transition opportunities. As a result, a return on investment (ROI) of the measure is improved.

Hereinafter, the present embodiment will be described in detail.

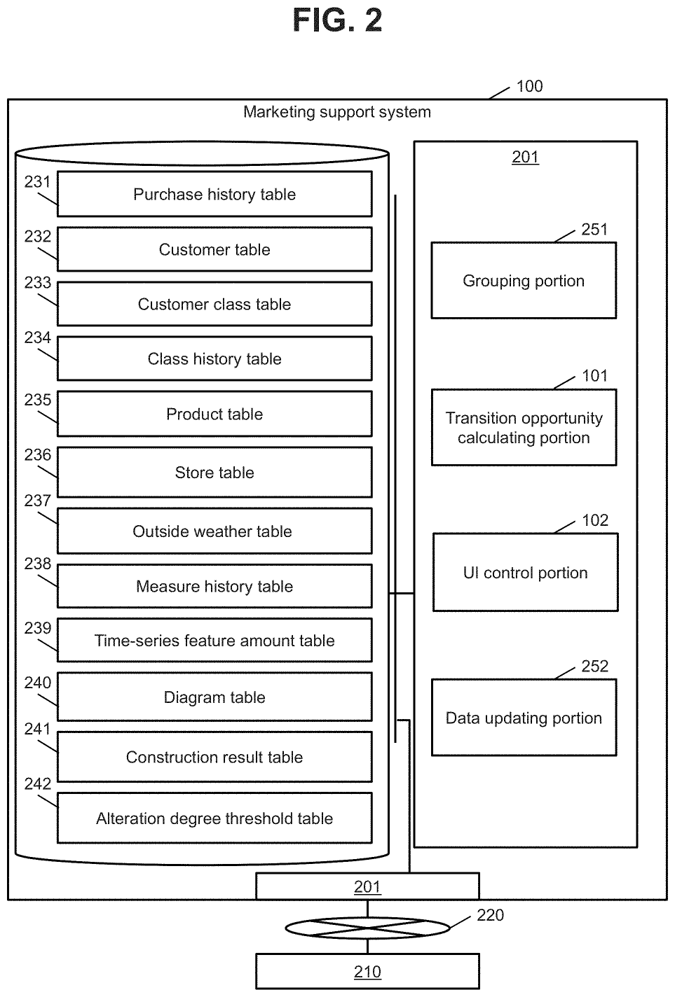

FIG. 2 shows a configuration of the marketing support system 100.

The marketing support system 100 has an interface apparatus 201, a storage apparatus 202, and a processor 203 coupled to the interface apparatus 201 and the storage apparatus 202.

A computer 210 equipped with an input device and a display device is coupled to the interface apparatus 201 via a network (for example, the Internet) 220. Instead thereof or in addition thereto, an input device and a display device may be coupled to the interface apparatus 201.

The storage apparatus 202 stores management data and one or more programs (not illustrated). For example, the management data includes a purchase history table 231, a customer table 232, a customer class table 233, a class history table 234, a product table 235, a store table 236, an outside weather table 237, a measure performance table 238, a time-series feature amount table 239, a diagram table 240, a construction result table 241, and an alteration degree threshold table 242. Tables 231, 234, and 237 to 239 are examples of data related to history. Among the management data, tables 232, 233, 235, 236, and 240 to 242 other than the tables 231, 234, and 238 to 239 are examples of relevant data.

When one or more programs in the storage apparatus 202 are executed by the processor 203, functions such as a grouping portion 251, the transition opportunity calculating portion 101, the UI control portion 102, and a data updating portion 252 are realized. The grouping portion 251 classifies a plurality of customers into a plurality of customer groups (a plurality of customer clusters). The data updating portion 252 updates the management data.

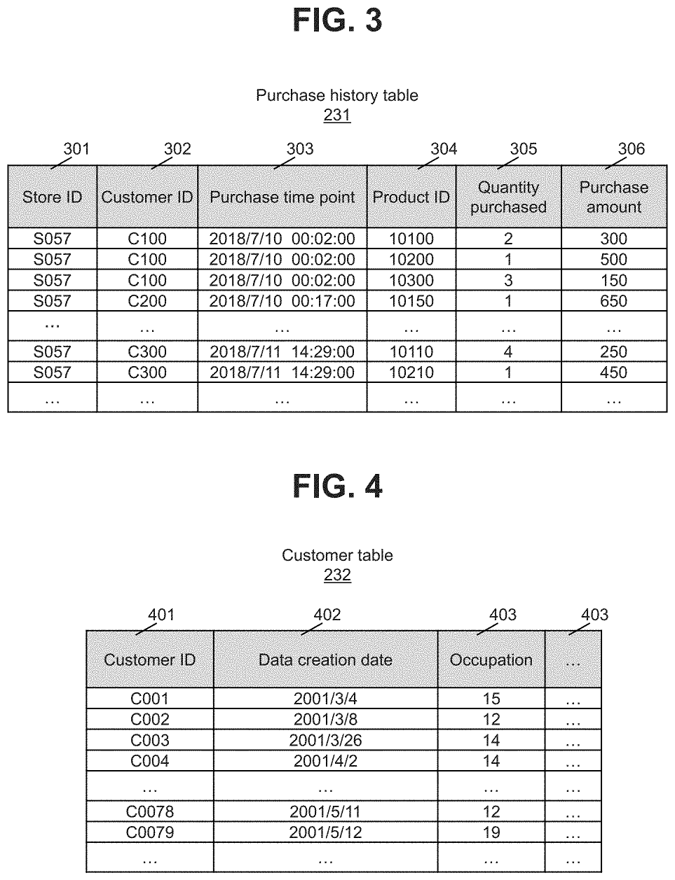

The tables 231 to 241 will be described with reference to FIGS. 3 to 13.

FIG. 3 shows a configuration of the purchase history table 231.

The purchase history table 231 holds information related to purchase histories of customers. For example, the purchase history table 231 has a record for each product that is a purchase target in one purchase. Each record holds information such as a store ID 301, a customer ID 302, a purchase time point 303, a product ID 304, a quantity purchased 305, and a purchase amount 306. Hereinafter, a single product will be described as an example (a “product of focus” in the description of FIG. 3).

The store ID 301 indicates an ID of a store where the product of focus had been purchased. The customer ID 302 indicates an ID of a customer who had purchased the product of focus. The purchase time point 303 indicates a time point at which the product of focus had been purchased (for example, a time point of payment for the product of focus). The product ID 304 indicates an ID of the product of focus. The quantity purchased 305 indicates the number of purchased products of focus. The purchase amount 306 indicates a total amount of money in accordance with a unit price of the product of focus and the quantity purchased 305.

FIG. 4 shows a configuration of the customer table 232.

The customer table 232 holds information related to customers. For example, the customer table 232 has a record for each customer. Each record holds information such as a customer ID 401, a generation date 402, and one or more feature amounts 403. Hereinafter, a single customer will be described as an example (a “customer of focus” in the description of FIG. 4).

The customer ID 401 indicates an ID of the customer of focus. The generation date 402 indicates a date on which the record of the customer of focus had been added. The one or more feature amounts 403 indicate one or more feature amounts (for example, sex or occupation) of the customer of focus.

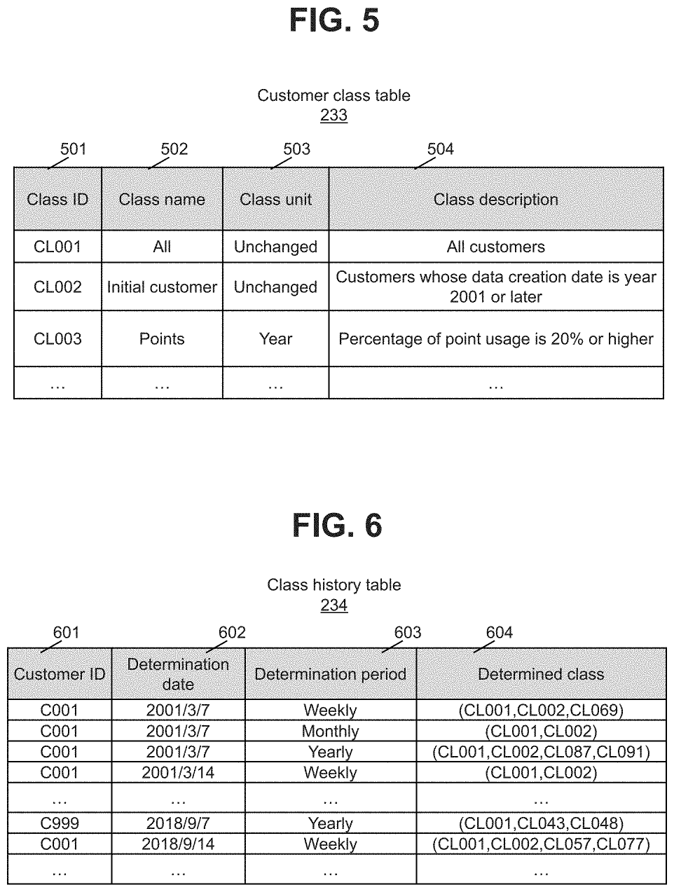

FIG. 5 shows a configuration of the customer class table 233.

The customer class table 233 holds information related to customer classes. For example, the customer class table 233 has a record for each customer class. Each record holds information such as a class ID 501, a class name 502, a class unit 503, and a class description 504. Hereinafter, a single customer class will be described as an example (a “class of focus” in the description of FIG. 5).

The class ID 501 indicates an ID of the class of focus. The class name 502 indicates a name of the class of focus. The class unit 503 indicates a unit of a time segment. The class description 504 indicates a description of the class of focus.

FIG. 6 shows a configuration of the class history table 234.

The class history table 234 holds information as histories of corresponding customer classes of customers. For example, the table 234 may be regularly updated by the data updating portion 252 on the basis of the tables 231 to 233. For example, the class history table 234 has a record for each combination of a customer, a determination date of a customer class, and a time segment unit. Each record holds information such as a customer ID 601, a determination date 602, a determination period 603, and a determined class 604. The customer ID 601 indicates an ID of a customer. The determination date 602 indicates a determination date of a determined class group (one or more customer classes) of the customer. The determination period 603 indicates a time segment unit corresponding to the determined class group of the customer. The determined class 604 indicates the determined class group of the customer.

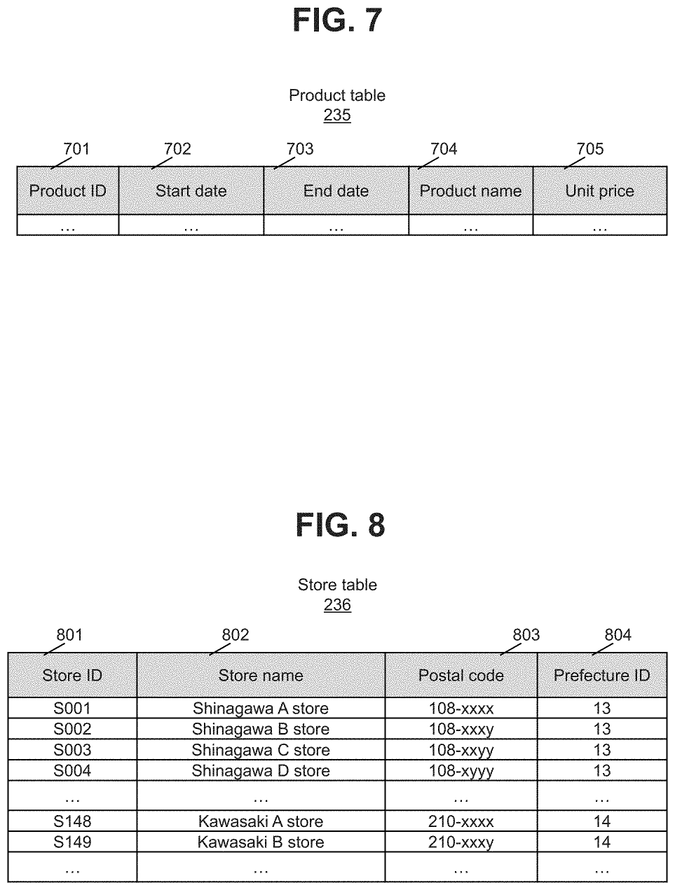

FIG. 7 shows a configuration of the product table 235.

The product table 235 holds information related to products. For example, the product table 235 has a record for each product. Each record holds information such as a product ID 701, a start date 702, an end date 703, a product name 704, and a unit price 705. Hereinafter, a single product will be described as an example (a “product of focus” in the description of FIG. 7).

The product ID 701 indicates an ID of the product of focus. The start date 702 indicates a date on which sales of the product of focus had started. The end date 703 indicates a date on which sales of the product of focus had ended. The product name 704 indicates a name of the product of focus. The unit price 705 indicates a unit price (price) of the product of focus.

FIG. 8 shows a configuration of the store table 236.

The store table 236 holds information related to stores. For example, the store table 236 has a record for each store. Each record holds information such as a store ID 801, a store name 802, a postal code 803, and a prefecture ID 804. Hereinafter, a single store will be described as an example (a “store of focus” in the description of FIG. 8).

The store ID 801 indicates an ID of the store of focus. The store name 802 indicates a name of the store of focus. The postal code 803 indicates a postal code of the store of focus. The prefecture ID 804 indicates an ID of a prefecture in which the store of focus is located.

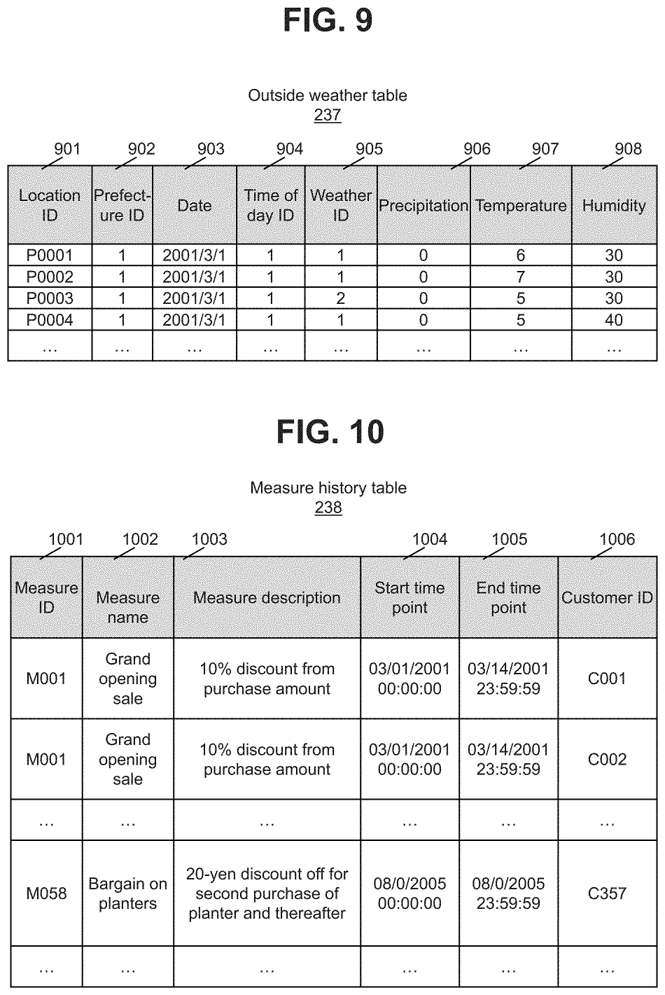

FIG. 9 shows a configuration of the outside weather table 237.

The outside weather table 237 holds information related to histories of weather. For example, the outside weather table 237 has a record for each combination of a point and a date. Each record holds information such as a point ID 901, a prefecture ID 902, a date 903, a time of day ID 904, a weather ID 905, precipitation 906, temperature 907, and humidity 908. The point ID 901 indicates an ID of a point.

The prefecture ID 902 indicates an ID of a prefecture in which the point is located. The date 903 indicates a date on which weather had been observed. The time of day ID 904 indicates a time of day of observation of the weather. The weather ID 905 indicates an ID of the observed weather. The precipitation 906, the temperature 907, and the humidity 908 indicate observed precipitation, temperature, and humidity. For example, on the basis of a table (not illustrated) indicating a relationship between point IDs and postal codes, from the store table 236 and the outside weather table 237, the transition opportunity calculating portion 101 can identify which store is present and what kind of weather was observed at any given point in a transition opportunity calculation process.

FIG. 10 shows a configuration of the measure performance table 238.

The measure performance table 238 holds information related to performances of measures. For example, the measure performance table 238 has a record for each implemented measure. Each record holds information such as a measure ID 1001, a measure name 1002, a measure description 1003, a start time point 1004, an end time point 1005, and a customer ID 1006. Hereinafter, a single measure will be described as an example (a “measure of focus” in the description of FIG. 10).

The measure ID 1001 indicates an ID of the measure of focus. The measure name 1002 indicates a name of the measure of focus. The measure description 1003 indicates a description (contents) of the measure of focus. The start time point 1004 indicates a time point at which the measure of focus had been started. The end time point 1005 indicates a time point at which the measure of focus had been ended. The customer ID 1006 indicates an ID of each of one or more customers for which the measure of focus had been implemented.

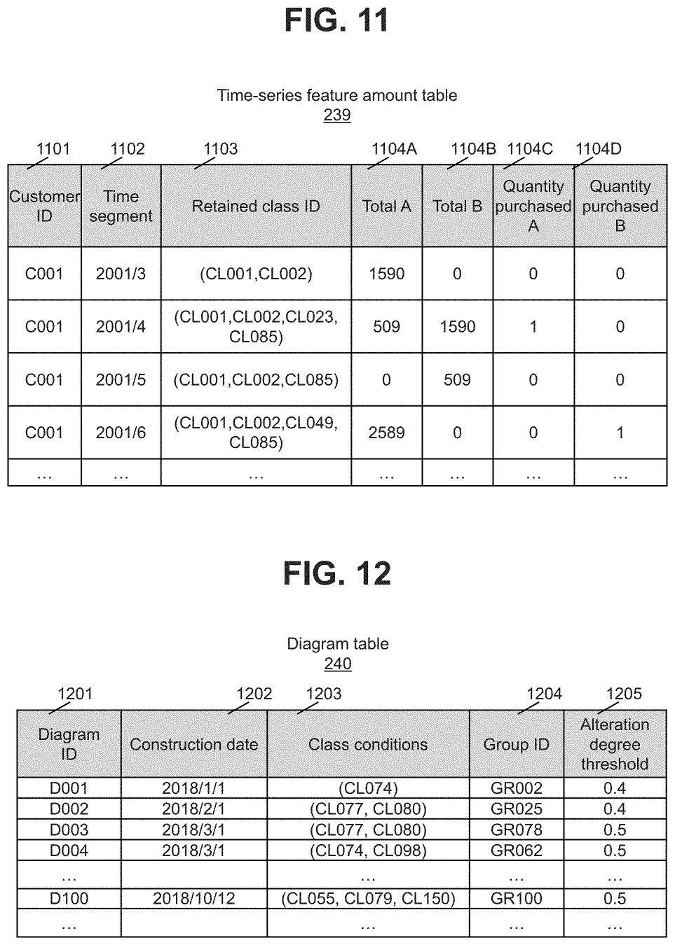

FIG. 11 shows a configuration of the time-series feature amount table 239.

The time-series feature amount table 239 is a table generated by the transition opportunity calculating portion 101 on the basis of the tables 231, 232, 234, 237, and 238. For example, for each target belonging to any group, the time-series feature amount table 239 has a plurality of records respectively including one or more feature amounts which respectively belong to a plurality of time segments in a time series and which are related to a history of the target. Each record holds information such as a customer ID 1101, a time segment 1102, a retained class ID 1103, and one or more feature amounts 1104. Hereinafter, a single customer will be described as an example (a “customer of focus” in the description of FIG. 11).

The customer ID 1101 indicates an ID of the customer of focus. The time segment 1102 indicates a time segment. The retained class ID 1103 indicates an ID of each of one or more customer classes corresponding to the customer of focus with respect to the time segment.

The one or more feature amounts 1104 indicate one or more feature amounts obtained from the tables 231, 232, 237, and 238 with respect to the customer of focus. For example, the feature amounts 1104 include information 1104A indicating a sum of purchase amounts for the present month, information 1104B indicating a sum of purchase amounts for the previous month, information 1104C indicating a purchased quantity of a product A, and information 1104D indicating a purchased quantity of a product B. In addition, as the feature amounts 1104, instead of or in addition to at least a part of the pieces of information 1104A to 1104D, other feature amounts such as information indicating the sex of the customer of focus may be provided.

FIG. 12 shows a configuration of the diagram table 240.

The diagram table 240 holds information related to transition diagrams of customer groups. In other words, in the following description, a “transition diagram” refers to a diagram with respect to one customer group. For example, the diagram table 240 has a record for each transition diagram. Each record holds information such as a diagram ID 1201, a construction date 1202, class conditions 1203, a group ID 1204, and an alteration degree threshold 1205. Hereinafter, a single transition diagram will be described as an example (a “diagram of focus” in the description of FIG. 12).

The diagram ID 1201 indicates an ID of the diagram of focus. The construction date 1202 indicates a date on which the diagram of focus had been constructed (generated). The class conditions 1203 indicate class conditions (an ID of each of one or more customer classes) associated with a customer group corresponding to the diagram of focus. The group ID 1204 indicates an ID of the customer group corresponding to the diagram of focus. The alteration degree threshold 1205 indicates an alteration degree threshold corresponding to the customer group corresponding to the diagram of focus. For example, the alteration degree threshold table 242 holds an alteration degree threshold for each customer group and, using the table 242, an alteration degree threshold corresponding to the customer group corresponding to the diagram of focus is registered as the alteration degree threshold 1205.

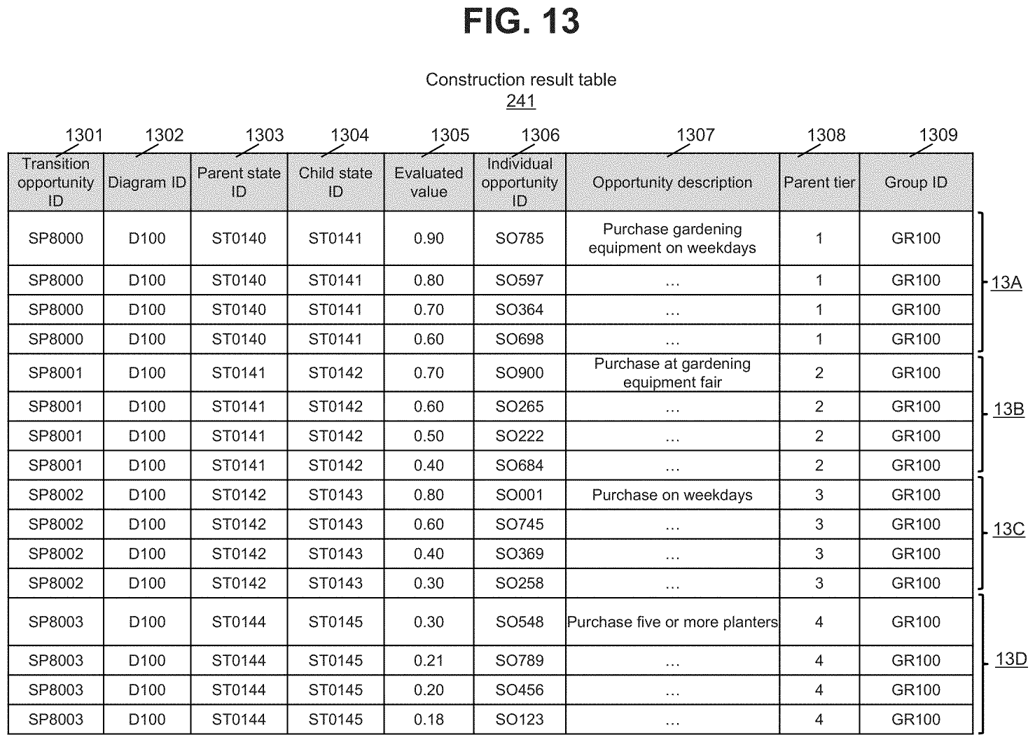

FIG. 13 shows a configuration of the construction result table 241.

The construction result table 241 holds information related to details of one or more constructed transition diagrams. For example, the construction result table 241 has a record for each individual transition opportunity. An “individual transition opportunity” is a transition opportunity calculated with respect to a single customer (an opportunity for making a transition from a given state to a next state with respect to the customer). In other words, in the present embodiment, one or a plurality of individual transition opportunities are calculated for each customer belonging to each customer group and, on the basis of a result thereof, one or a plurality of state transition opportunities are calculated with respect to the customer group as will be described in detail later. Each record holds information such as a transition opportunity ID 1301, a diagram ID 1302, a parent state ID 1303, a child state ID 1304, an evaluated value 1305, an individual opportunity ID 1306, an opportunity description 1307, a parent tier 1308, and a group ID 1309. Hereinafter, a single individual transition opportunity will be described as an example (an “opportunity of focus” in the description of FIG. 13).

The transition opportunity ID 1301 indicates an ID of a state transition opportunity to which the opportunity of focus belongs. The diagram ID 1302 indicates an ID of a transition diagram corresponding to a customer group for which the opportunity of focus had been calculated. The parent state ID 1303 indicates an ID of a state prior to a transition by the state transition opportunity to which the opportunity of focus belongs. The child state ID 1304 indicates an ID of a state after a transition by the state transition opportunity to which the opportunity of focus belongs. The evaluated value 1305 indicates an evaluated value of the opportunity of focus. The individual opportunity ID 1306 indicates an ID of the opportunity of focus. The opportunity description 1307 indicates a description (contents) of the opportunity of focus. The parent tier 1308 indicates the number of a tier to which belongs the state prior to a transition by the state transition opportunity to which the opportunity of focus belongs. The group ID 1309 indicates an ID of the customer group for which the opportunity of focus had been calculated.

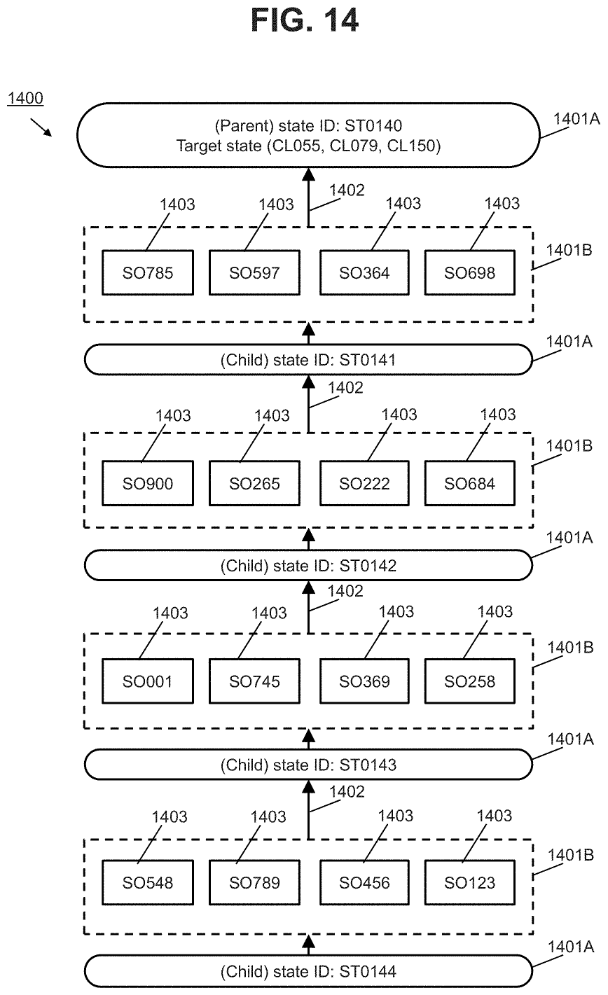

FIG. 14 shows an expression of a first kind of a transition diagram with a diagram ID “100”.

A transition diagram 1400 in accordance with the expression of the first kind is typically displayed on a graphical user interface (GUI) provided by the UI control portion 102 and is a tree structure constituted by a plurality of nodes 1401 and a plurality of edges 1402 connecting the plurality of nodes 1401. A “node” and an “edge” are terms used in directed graphs. “Node” and “edge” may be respectively replaced with other terms. For example, a “node” may be referred to as a “vertex”. An “edge” may be referred to as a “link”, a “line”, or a “branch”.

The node 1401 is at least a node 1401B among a node 1401A corresponding to a state and the node 1401B corresponding to a state transition opportunity.

A highest tier is a target state. With the target state as a tier 0 (a tier with a level number of “0”), tiers are displayed from 1 to 4. The closer a tier (a state) is to the target state, the smaller the number of the level. With respect to two states on either side of a single state transition opportunity, when the state farther from the target state is a reference, the state closer to the target state is a parent state, and when the state closer to the target state is a reference, the state farther from the target state is the parent state.

With respect to at least one node 1401, instead of or in addition to an ID of a state or an opportunity corresponding to the node 1401, information such as a text to be displayed in the node 1401 may be other kinds of information related to the state or the opportunity corresponding to the node 1401. In addition, with respect to at least one node 1401, when the node 1401 is designated by a user (or without being designated), details (for example, a description) related to the state or the opportunity corresponding to the node 1401 may be displayed.

According to the expression of the first kind, each node 1401B includes one or more display objects 1403 respectively corresponding to one or more individual transition opportunities belonging to a state transition opportunity to which the node 1401B corresponds. With respect to the one or more display object 1403, instead of or in addition to an ID of an opportunity corresponding to the display object 1403, information such as a text to be displayed in the display object 1403 may be other kinds of information related to the opportunity corresponding to the display object 1403. In addition, with respect to at least one display object 1403, when the display object 1403 is designated by a user (or without being designated), details (for example, a description) related to the opportunity corresponding to the display object 1403 may be displayed.

According to FIG. 14, nodes 1401B1 to 1401B4 respectively correspond to record groups 13A to 13D in FIG. 13.

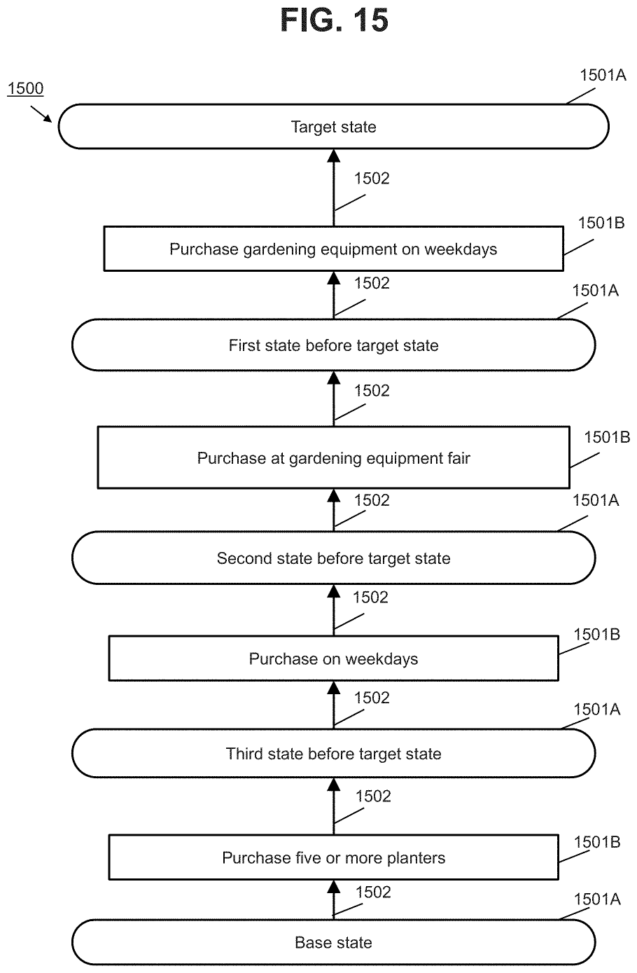

FIG. 15 shows an expression of a second kind of the transition diagram with the diagram ID “100”.

A transition diagram 1500 in accordance with the expression of the second kind is also a tree structure constituted by a plurality of nodes 1501 and a plurality of edges 1502. The node 1501 is at least a node 1501B among a node 1501A corresponding to a state and the node 1501B corresponding to a state transition opportunity.

The expression of the second kind corresponds to a simplified version of the expression of the first kind. In other words, the node 1501B is simpler in configuration than the node 1401B and, specifically, a description of a state transition opportunity is displayed but a description of each individual transition opportunity belonging to the state transition opportunity is not displayed.

According to the expression of the second kind, the user can promptly comprehend each state transition opportunity up to the target state, and according to the expression of the first kind, the user can comprehend details of each state transition opportunity.

As expressions of a transition diagram, expressions of other kinds may be provided instead of or in addition to at least one of the expression of the first kind and the expression of the second kind described above. The UI control portion 102 may receive a designation from the user as to which kind of expression is to be adopted among a plurality of kinds of expressions and may display a transition diagram expressed according to the designated kind of expression.

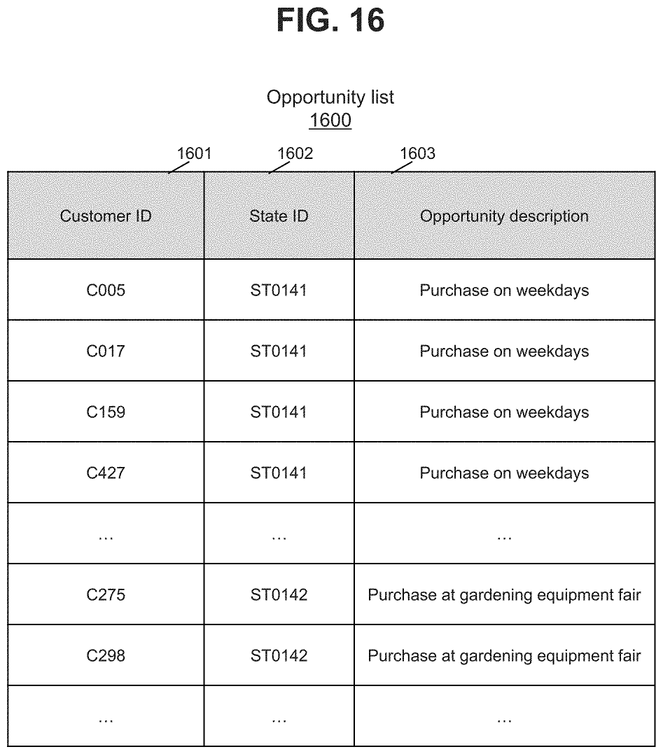

In addition, instead of displaying calculated state transition opportunities on a transition diagram, the UI control portion 102 may display the calculated state transition opportunities on a list such as that illustrated in FIG. 16.

FIG. 16 shows an opportunity list as an example of output information.

An opportunity list 1600 indicates a relationship between customers (or customer groups) and transition opportunities. Specifically, for example, the opportunity list 1600 has an entry for each customer belong to a designated customer group or for each designated customer. Each entry holds information such as a customer ID 1601, a state ID 1602, and an opportunity description 1603. The customer ID 1601 indicates an ID of the customer. The state ID 1602 indicates an ID of any of child states corresponding to the customer. The opportunity description 1603 indicates a description of a state transition opportunity for making a transition from the child state to a parent state.

For example, let us assume that a customer range (for example, one or more customers who constitute all of or a part of a customer group) to be considered a target state when implementing a measure is designated. The entry illustrated in FIG. 16 is added to and displayed on the opportunity list 1600 for each customer belonging to the designated customer range. Due to the list 1600, a measure construction perspective with respect to each individual customer belonging to the customer range can be provided from a state transition opportunity and materialization of a measure can be supported.

Hereinafter, an example of a process performed in the present embodiment will be described.

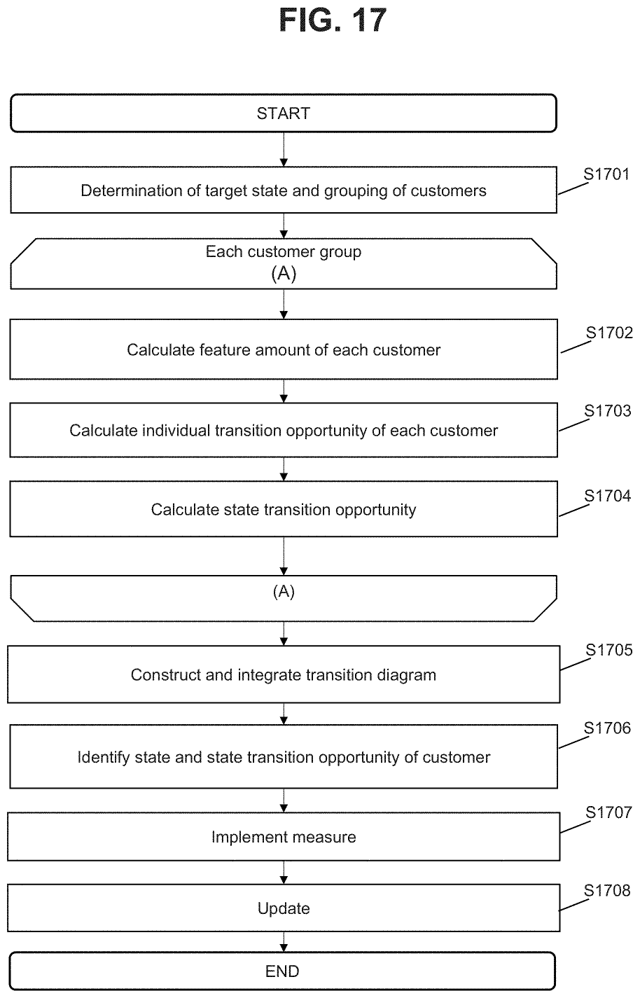

FIG. 17 shows a flow of a marketing support process performed in the present embodiment.

The user determines a target state and the grouping portion 251 classifies a plurality of customers into a plurality of customer groups (S1701).

S1702 to S1704 are performed for each customer group. In an example of a single customer group (a “target group” in the description of FIG. 17), the process is carried out as follows. The transition opportunity calculating portion 101 calculates a feature amount for each customer belonging to the target group (S1702), and calculates an individual transition opportunity on the basis of the calculated feature amount (S1703). On the basis of one or more individual transition opportunities of each customer belonging to the target group, the transition opportunity calculating portion 101 calculates one or a plurality of state transition opportunities with respect to the target group (S1704).

The UI control portion 102 constructs a plurality of transition diagrams corresponding to a plurality of customer groups and integrates the plurality of transition diagrams (S1705). As a result, an integrated transition diagram is obtained. The UI control portion 102 displays the integrated transition diagram or a transition diagram corresponding to a customer group desired by the user as an example of output information in accordance with the results of S1701 to S1704.

The user views the displayed output information (for example, the integrated transition diagram or the transition diagram corresponding to the customer group desired by the user) and, with respect to each customer belonging to a customer range, identifies a state transition opportunity for making a transition from a state of the customer to a next state (S1706), and implements a measure determined on the basis of the identified state transition opportunity with respect to the customer (S1707). In accordance with the implementation of the measure in S1707, the data updating portion 252 updates the management data (at least the measure performance table 238) (S1708). Due to performing S1701 to S1705 on the basis of the updated management data, the updated output information (for example, the integrated transition diagram or the transition diagram corresponding to the customer group desired by the user) is displayed by the UI control portion 102.

Hereinafter, details of S1701 to S1705 will be described.

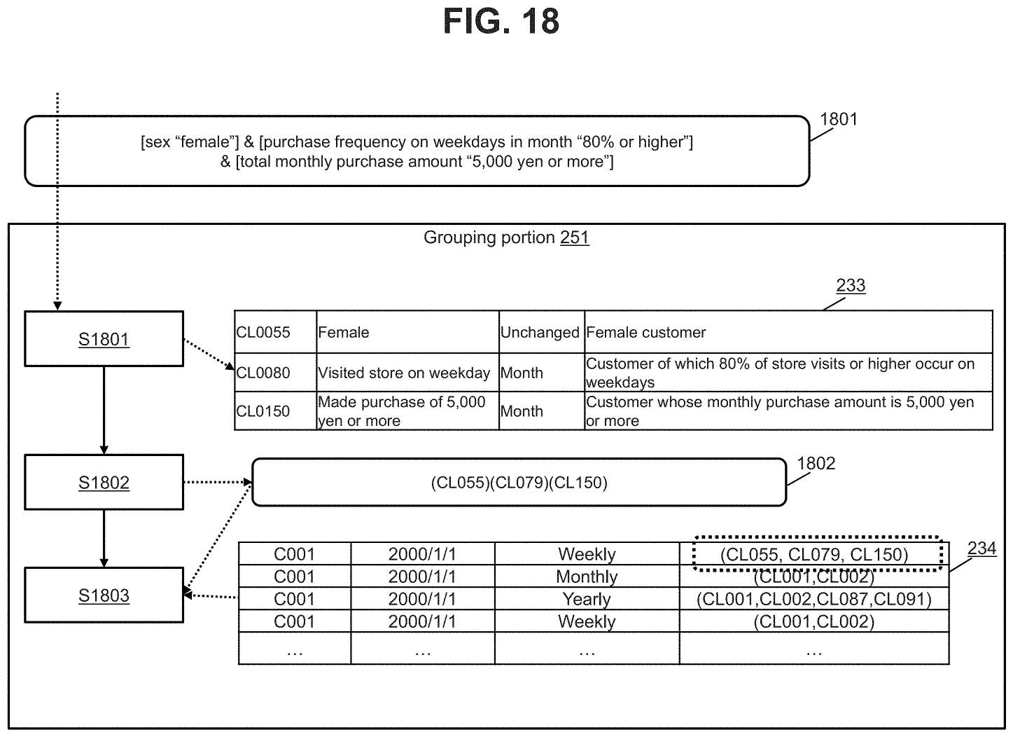

FIG. 18 shows an example of details of S1701.

Let us assume that S1702 to S1704 are to be performed by considering all of the customers to be a single customer group. In this case, a variation in feature amounts among the customers may be too large to obtain a transition opportunity with commonality. By performing S1702 to S1704 for each customer group obtained through the grouping in S1701 (in other words, each group to which a customer attribute (one or more classes) is associated), a state transition opportunity is obtained with respect to the customer group.

While the customer class table 233 may be prepared in advance, in the present embodiment, customer classes can be defined by the grouping portion 251.

For example, the grouping portion 251 determines one or more customer classes from a target state 1801 designated by the user via the UI control portion 102, and adds information related to each of the one or more determined customer classes to the customer class table 233 (S1801). Specifically, for example, the target state 1801 is constituted by one or more element units, and one or more customer classes respectively corresponding to the one or more element units are determined.

The grouping portion 251 generates class conditions 1802 (for example, a set of class IDs) constituted by the one or more determined customer classes (S1802). In this case, it is assumed that the class conditions 1802 “(CL055, CL079, CL150)” are generated.

The grouping portion 251 extracts a customer corresponding to the generated class conditions 1802 from the class history table 234 (S1803). In S1803, for example, a customer having previously corresponded to one or more customer classes including all of the one or more customer classes constituting the class conditions 1802 (for example, as indicated by a dotted frame, a customer with the customer ID “C001”) is extracted from the class history table 234. Each customer extracted in S1803 is a customer belonging to a customer group with which the class conditions 1802 are associated.

It should be noted that a method of grouping (clustering) is not limited to the method described with reference to FIG. 18. For example, K-means clustering with respect to a transition feature on the basis of the determined class 604 of the customer extracted from the class history table 234 may be adopted.

In addition, each customer extracted on the basis of the target state 1801 is a customer having previously reached at least a part of the element units of the target state 1801 (for example, according to the example shown in FIG. 18, the customer with the customer ID “C001”). A plurality of customer groups are respectively associated with a plurality of class groups (one or more customer classes) respectively corresponding to the plurality of element units constituting the target state 1801. In this manner, a customer corresponding to a history used to calculate a state transition opportunity is a customer who has previously reached at least a part of the element units of the target state 1801 at least once (a customer who has previously corresponded to a class group corresponding to at least a part of the element units of the target state 1801 at least once) and, since the state transition opportunity is calculated using such a history related to a customer, it is anticipated that a state transition opportunity with a high possibility of guidance to the target state may be provided.

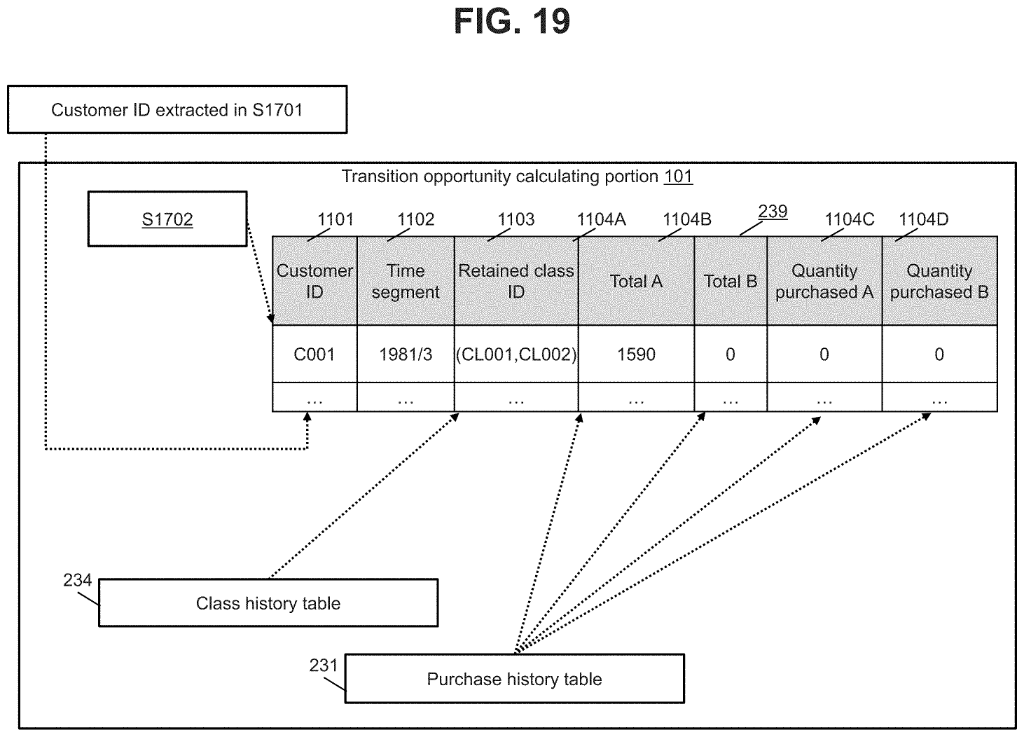

FIG. 19 shows an example of details of S1702. Hereinafter, in the description of details of S1702 to S1704 (a description with reference to FIGS. 19 to 23), one customer group or, more specifically, a customer group with which class conditions “(CL055, CL079, CL150)” are associated will be used as an example (a “group of focus” in the description of FIGS. 19 to 23).

In S1702, the transition opportunity calculating portion 101 generates the time-series feature amount table 239 on the basis of at least one of the tables 231, 232, 234, 237, and 238. The table 239 is used to calculate, for each time segment, a difference in feature amounts between the time segment and a preceding time segment with respect to each customer belonging to the group of focus (in other words, each customer extracted in S1701 due to the determined class 604 of the customer having previously corresponded to the class conditions 1802). For example, the following descriptions apply to the table 239.

Customer IDs of the respective customers belonging to the group of focus are aligned in the column of the customer ID 1101.

A plurality of time segments are aligned in the column of the time segment 1102 in a time segment unit in accordance with the determination period 603 (for example, “monthly”) corresponding to the determined class 604 corresponding to the class conditions 1802. The plurality of time segments need not necessarily be uniform segments. In addition, the time segment being “1981/3” in the table 239 despite the period being “2000/1” in the table 234 in FIG. 18 is because the time segment is an oldest time segment from which a feature amount can be acquired with respect to the customer ID “C001”. Whichever time segment is to be considered the oldest may be arbitrarily designated. In addition, as will be described later, the present invention can be applied to management support other than marketing support, and a time segment is an example of a segment.

Class ID combinations extracted from the class history table 234 using the customer ID 1101 and the time segment 1102 as keys are aligned in the column of the retained class ID 1103.

Feature amounts identified from at least one of the tables 231, 232, 234, 237, and 238 are aligned in the column of the feature amount 1104.

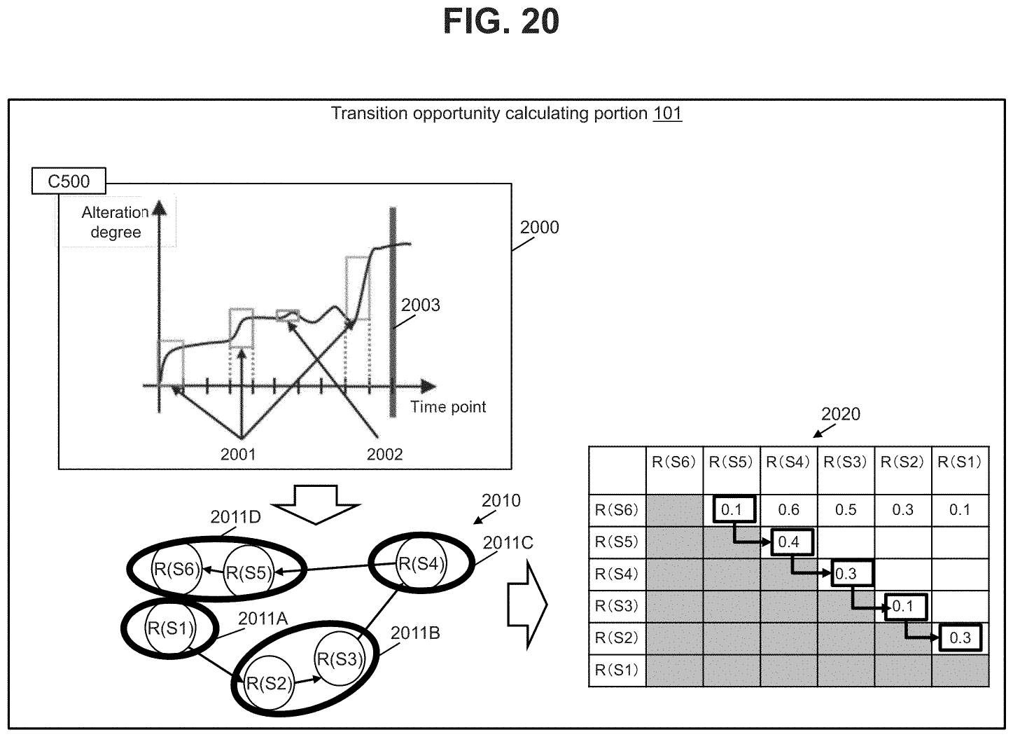

FIG. 20 shows an example of details of S1703.

The transition opportunity calculating portion 101 calculates one or more individual transition opportunities for each customer belonging to the group of focus. For example, using a customer with the customer ID “C500” (a “customer of focus” in the description of FIGS. 20 to 23) as illustrated as an example, each individual transition opportunity is an opportunity at which a state of the customer of focus had made a transition to a next state. In FIG. 20, while a graph 2000 indicates a transition in an alteration degree of the customer of focus, the transition opportunity calculating portion 101 considers a range 2001 in which a variation in the alteration degree is relatively large to be an individual transition opportunity but does not consider a range 2002 in which a variation in the alteration degree is relatively small to be an individual transition opportunity.

In S1703, specifically, the transition opportunity calculating portion 101 performs the following for each customer by referring to the time-series feature amount table 239. In the description of FIGS. 20 to 23, class conditions “(CL055, CL079, CL150)” associated with a group of focus will be referred to as “class conditions of focus”.

(S2001) Determine a plurality of time segments including a time segment corresponding to the class conditions of focus.

(S2002) On the basis of an alteration degree of each time segment pair, determine one or more time segment pairs as one or more individual transition opportunities.

Hereinafter, S2001 and S2002 will be described using the customer of focus as an example.

For example, details of S2001 are as follows.

The transition opportunity calculating portion 101 determines a time series (TS) of the customer of focus. TS is a set of time segments. With respect to an arbitrary time segment, for example, expressions such as “TP(i)∈TS|i∈N (natural number)” and “1≤i≤length(TS)” can be adopted. As a specific example, TS is {“2017/2”, “2017/3”, . . . , “2017/7”, “2017/8”} or, in other words, eight consecutive monthly time segments from February 2017 to August 2017. Therefore, TS can also be expressed as {TP(1), TP(2), . . . , TP(8)}.

The transition opportunity calculating portion 101 defines a class set of the customer of focus. A class in TP(i) can be expressed as Class (TP(i)). At this point, for example, Class={“(CL100)”, “(CL100, CL200)”, . . . , “(CL011, CL055, CL079, CL150)”, “(CL055, CL079, CL150)”} is adopted as a specific example of a class set. This specific example means that, during a period from February 2017 to August 2017, the customer of focus has corresponded to the class conditions of focus “(CL055, CL079, CL150)” in July 2017 and August 2017.

The transition opportunity calculating portion 101 searches for a pertinent time segment pair (TP(i-1) and TP(i)) which is a time segment pair satisfying the following. A “time segment pair” is a pair of two consecutive time segments.
Class (TP(i-1)) does not satisfy the class conditions of focus.
Class (TP(i)) satisfies the class conditions of focus.

While a plurality of pertinent time segment pairs may be found, in the specific example described above, there is one pertinent time segment pair. This is because July 2017 and August 2017 both satisfy the class conditions of focus and are therefore not a pertinent time segment pair.

With respect to the time segment satisfying the class conditions of focus in a pertinent time segment pair, expressions such as “A_TP(j)|j∈N (natural number)” and “1 j≤length(A_TP)” can be adopted. In this specific example, A_TP={“2017/7”}. The A_TP corresponds to the time segment indicated by reference numeral 2003 in FIG. 20. In this case, “A_TP” refers to a time segment satisfying the class conditions of focus (Accomplish Time Point).

With respect to an arbitrary A_TP (a single A_TP in the specific example described above), the transition opportunity calculating portion 101 defines a set of time segments that satisfy the following.
{TP(s)|Class(TP(s))<A_TP(j), s∈N (natural number), 1≤s}

In the specific example described above, since B_TS of A_TP(1) satisfies the above, B_TS_of_A_TP(1)={“2017/2”, “2017/3”, . . . , “2017/6”}. In this case, “B_TS” refers to a set of previous time segments (Behind Time Series). The B_TS corresponds to one or more time segments which precede the time segment indicated by reference numeral 2003 in FIG. 20.

With respect to an arbitrary A_TP (a single A_TP in the specific example described above), the transition opportunity calculating portion 101 defines a B_TP. “B_TP” refers to any previous time segment (Behind Time Point). With respect to an arbitrary B_TS (B_TS_of_A_TP(j)), expressions such as B_TP(u)_of_A_TP(j)∈B_TS_of_A_TP(j)|u∈N (natural number), 1≤u≤length(B_TS_of_A_TP(j)) can be adopted. In the specific example described above, B_TS_of_A_TP(1)={“2017/2”, “2017/3”, . . . , “2017/6”}. B_TS_of_A_TP(1) can also be expressed as {B_TP(1)_A_TP(1), B_TP(2)_A_TP(1), . . . , B_TP(5)_A_TP(1)}.

As a result, A_TP={“2017/7”} and B_TS_A_TP(1))={“2017/2”, “2017/3”, . . . , “2017/6”} are obtained with respect to the customer of focus and, therefore, {“2017/2”, “2017/3”, “2017/4”, “2017/5”, “2017/6”, “2017/7”} are obtained as a plurality of time segments including the pertinent time segment.

For example, details of S2002 are as follows.

The transition opportunity calculating portion 101 calculates an alteration degree for each time segment pair among the plurality of time segments {“2017/2”, “2017/3”, “2017/4”, “2017/5”, “2017/6”, “2017/7”} obtained in S2001. Specifically, the calculation is performed as follows.
The transition opportunity calculating portion 101 identifies a record set (a plurality of records) corresponding to the plurality of time segments {“2017/2”, “2017/3”, “2017/4”, “2017/5”, “2017/6”, “2017/7”} of the customer of focus from the time-series feature amount table 239. The record set can be expressed as “Rec (“C500”, “2017/2”), Rec (“C500”, “2017/3”), . . . , Rec (“C500”, “2017/7”)” or abbreviated as “R(S1), R(S2), . . . , R(S6)”.
With respect to each time segment pair, the transition opportunity calculating portion 101 calculates an alteration degree on the basis of a difference (for example, a cosine similarity) between one or more feature amounts 1104 of one of two records corresponding to the pertinent time segment pair and one or more feature amounts 1104 of the other record.

Let us assume that, with respect to each of R(S1), R(S2), . . . , R(S6), an example of a logical position in accordance with one or more feature amounts 1104 of a pertinent record is as indicated by reference numeral 2010. According to this example, the alteration degree (distance) between R(S6) corresponding to the pertinent time segment and R(S1) corresponding to a previous time segment most separated from the pertinent time segment is small. In other words, while the alteration degree between R(S1) and R(S6) is minute, in the present embodiment, an alteration degree does not indicate ease of transition and whether or not a transition can be made is determined based on history. As described earlier, in the present embodiment, a “time segment pair” is a pair of two consecutive time segments. Therefore, an alteration degree is not calculated with respect to two non-consecutive time segments (records). In other words, with respect to all record pairs (time segment pairs) in a record set, alteration degrees are sequentially calculated in a direction from a record at one end of the record set (for example, a record corresponding to an oldest or a newest time segment) to a record at the other end of the record set (for example, a record corresponding to a newest or an oldest time segment). According to reference numeral 2010, one or more records (time segments) of which the alteration degree is lower than a threshold is enclosed by ellipses 2011. The record sets (time segment sets) in the ellipses 2011 correspond to “states” in the present embodiment. In other words, according to the example denoted by reference numeral 2010, the customer of focus currently satisfies the class conditions of focus after making a transition from a state 2011A to a state 2011B, a transition from the state 2011B to a state 2011C, and a transition from the state 2011C to a state 2011D.

According to the example denoted by reference numeral 2020, the transition opportunity calculating portion 101 calculates an alteration degree for each record pair in a record set (a time segment set) and identifies one or more record pairs (time segment pairs) corresponding to alteration degrees equal to or higher than a threshold. For example, let us assume that an alteration degree threshold is 0.3, a given record is denoted by X, a time segment immediately preceding a time segment corresponding to the record X is denoted by Y (=X-1), and an alteration degree between the records is denoted by CH (X, Y). The transition opportunity calculating portion 101 sequentially calculates CH (X, Y) from a newest record pair to an oldest record pair. As a result, CH(R(S5), R(S4)), CH(R(S4), R(S3)), and CH(R(S2), R(S1)) are found to be equal to or higher than the alteration degree threshold. Therefore, a time segment pair (“2017/5”, “2017/6”) corresponding to CH(R(S5), R(S4)), a time segment pair (“2017/4”, “2017/5”) corresponding to CH(R(S4), R(S3)), and a time segment pair (“2017/2”, “2017/3”) corresponding to CH(R(S2), R(S1)) respectively correspond to individual transition opportunities of the customer of focus.

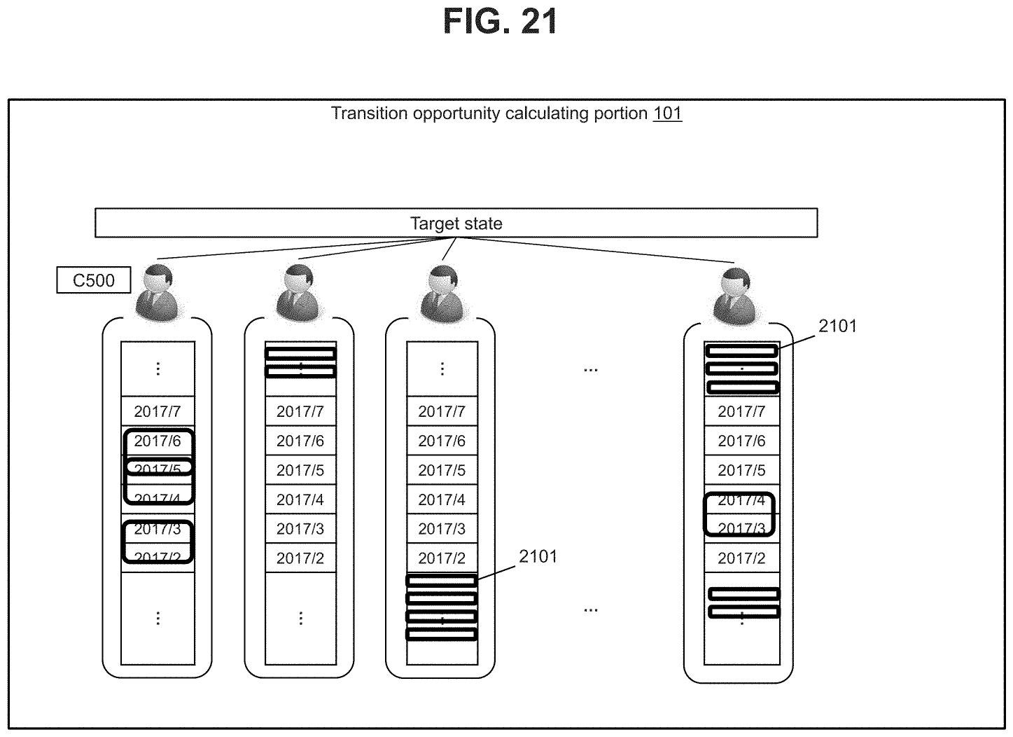

FIGS. 21 to 23 show an example of details of S1704.

As illustrated in FIG. 21, for each customer belonging to the group of focus, there are one or more individual transition opportunities (time segment pairs) 2101 found with respect to the customer. However, as illustrated in FIG. 21, timings (positions on a time axis) of individual transition opportunities 2101 are not necessarily the same for a plurality of customers belonging to the group of focus. Therefore, it is difficult to define a state transition opportunity with respect to the group of focus.

In consideration thereof, in the present embodiment, with respect to the group of focus, the transition opportunity calculating portion 101 defines an n-th (where n is a natural number) individual transition opportunity 2101 from the target state (or the base state) as an individual transition opportunity 2101 (hereinafter, an individual transition opportunity 2101-n) for making a transition from a state on an n-th tier to a state on an (n-1)-th tier for each customer for which at least one individual transition opportunity has been calculated. In addition, the transition opportunity calculating portion 101 determines an n-th state transition opportunity from the target state from all individual transition opportunities 2101-n corresponding to all customers belonging to the group of focus (customers for which at least one individual transition opportunity has been calculated).

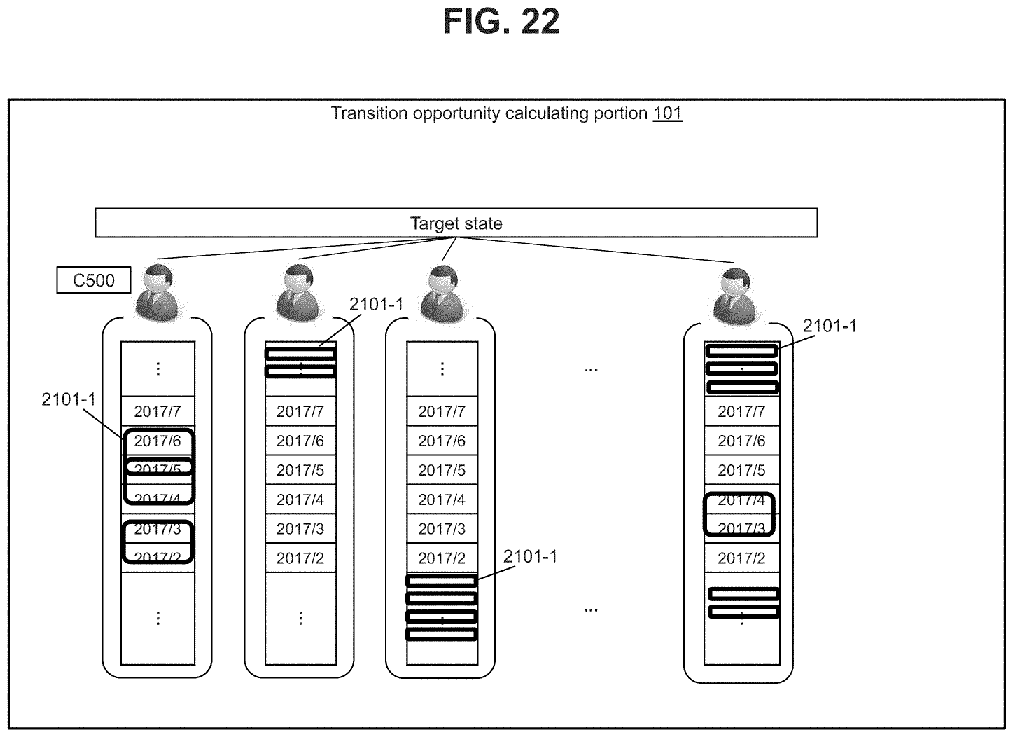

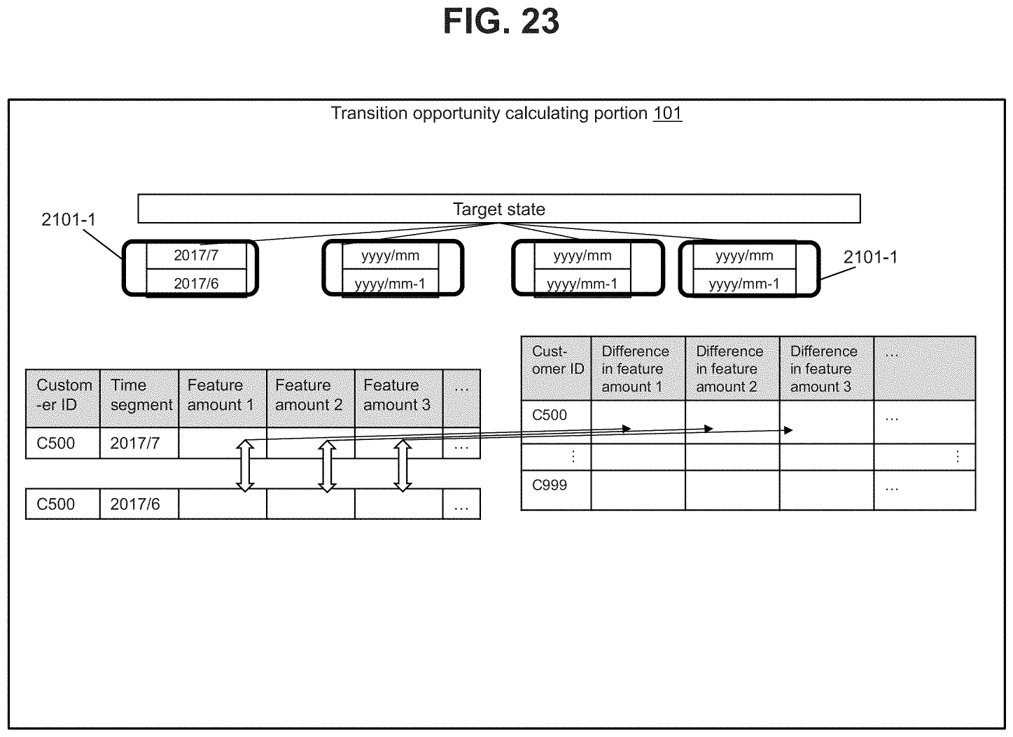

Let us use n=1 as an example. In this case, an example of a calculation of a state transition opportunity is as follows. Specifically, as illustrated in FIG. 22, the transition opportunity calculating portion 101 identifies all individual transition opportunities 2101-1 corresponding to all customers belonging to the group of focus. Subsequently, as illustrated in FIG. 23, the transition opportunity calculating portion 101 determines a first state transition opportunity with respect to the group of focus by performing a factorial analysis regarding a change from one or more feature amounts 1104 corresponding to a time segment prior to a transition to one or more feature amounts 1104 corresponding to the time segment after the transition with respect to each of the individual transition opportunities 2101-1. In the factorial analysis, for example, a change (a difference) from one or more feature amounts 1104 corresponding to the time segment prior to a transition to one or more feature amounts 1104 corresponding to the time segment after the transition is recorded for each customer, and the first state transition opportunity is determined based on the record.

Any method can be adopted for determining a single state transition opportunity from a plurality of individual transition opportunities. For example, when a given individual transition opportunity 2101-1 indicates an increase in a purchase amount from 200 yen to 1000 yen and another individual transition opportunity 2101-1 indicates an increase in the purchase amount from 400 yen to 1100 yen, the state transition opportunity may be an individual transition opportunity with a largest difference in purchase amounts, an individual transition opportunity with a smallest difference in purchase amounts, or an opportunity determined based on an average or the like of the individual transition opportunities.

The transition opportunity calculating portion 101 executes the processes described with reference to FIGS. 22 and 23 while incrementing the value of n by 1 until a condition such as an absence of remaining individual transition opportunities or the value of n reaching a prescribed value is satisfied with respect to at least one customer. An n-th tier state at a time point of completion of the processes may be adopted as the base state (a 0-th state is the target state).

As described above, one or a plurality of state transition opportunities are calculated with respect to each customer group.

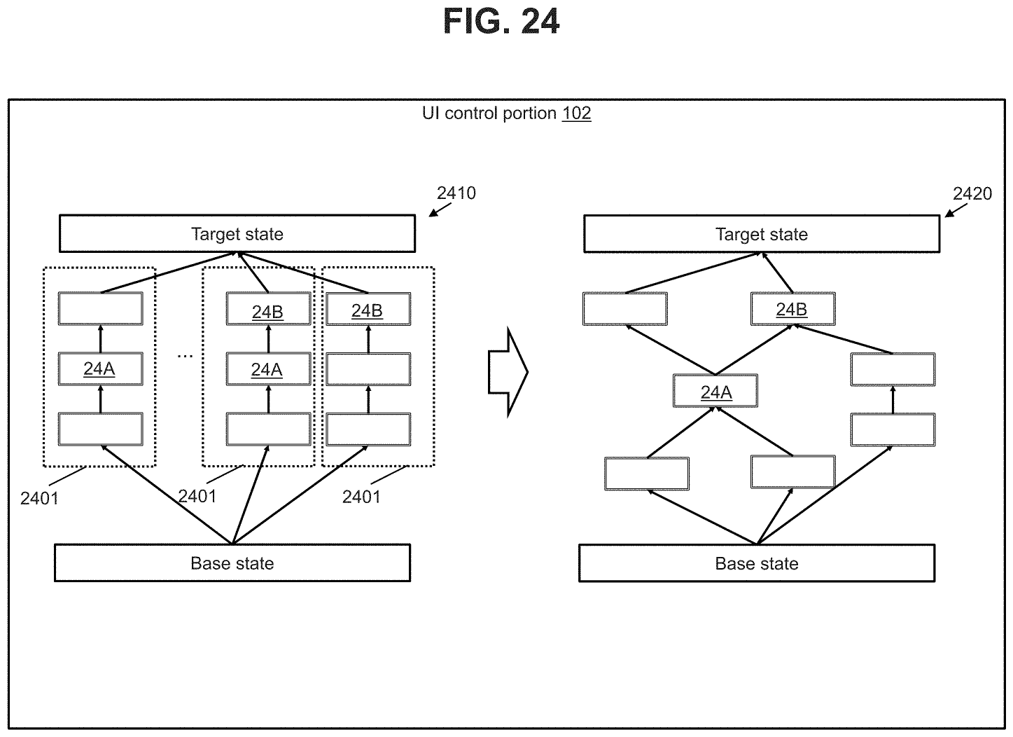

FIG. 24 shows an example of details of S1705.

For each customer group, the UI control portion 102 constructs a transition diagram including one or a plurality of nodes respectively corresponding to one or a plurality of state transition opportunities calculated with respect to the customer group and updates the diagram table 240 and the construction result table 241.

For example, the UI control portion 102 can display a transition diagram 2410 with respect to a plurality of customer groups of which the target state is the same. The transition diagram 2410 is a transition diagram of which the base state and the target state have been commonalized among a plurality of transition diagrams respectively corresponding to the plurality of customer groups and is substantially a transition diagram per customer group. In other words, the transition diagram 2410 has a plurality of opportunity node groups 2401 respectively corresponding to the plurality of customer groups. Each opportunity node group 2401 includes one or a plurality of opportunity nodes 24 respectively corresponding to one or a plurality of state transition opportunities from the base state to the target state. The opportunity node 24 is a node indicating a state transition opportunity. According to the transition diagram 2410, a state transition opportunity is independent for each customer group. Therefore, even if there are two opportunity nodes 24A with a same content or two opportunity nodes 24B with a same content as two or more opportunity nodes with a same content (nodes corresponding to state transition opportunities with a same content) in two or more customer groups, each opportunity node 24A and each opportunity node 24B are present for each customer group.

When the UI control portion 102 receives an integration instruction from the user or when the UI control portion 102 identifies that state transition opportunities with a same content is present in two or more customer groups from the construction result table 241 for each customer group (each transition diagram), the UI control portion 102 integrates a plurality of transition diagrams respectively corresponding to the plurality of customer groups of which the target state is the same. As a result, an integrated transition diagram 2420 is generated. According to the integrated transition diagram 2420, the two or more opportunity nodes 24A and 24B with a same content in two or more customer groups are integrated into a single opportunity node 24A and a single opportunity node 24B. In this manner, bundling state transition opportunities with a same content across customer groups increases transition history paths to the target state in a transition diagram and increases options of measures (in other words, the number of measures to be potentially determined).

The description of FIGS. 19 to 24 given above can be summarized as follows.

For each customer belonging to a group of focus, the transition opportunity calculating portion 101 calculates, for each time segment pair, an alteration degree in accordance with a difference between one or more feature amounts 1104 corresponding to one of the time segments and one or more feature amounts 1104 corresponding to the other time segment and identifies the time segment pair as an individual transition opportunity if the calculated alteration degree is equal to or higher than an alteration degree threshold. When there is an individual transition opportunity group that is one or more individual transition opportunities with respect to at least one customer belonging to the group of focus, the transition opportunity calculating portion 101 calculates one or a plurality of state transition opportunities with respect to the group of focus on the basis of the one or more individual transition opportunities respectively corresponding to the one or more customers. Each time segment pair is a pair of two consecutive time segments. In this manner, state transition opportunities leading up to the target state can be accurately found from management data.

An n-th (where n is a natural number) state transition opportunity is an opportunity on the basis of one or more feature amount difference groups corresponding to one or more n-th individual transition opportunities in one or more individual transition opportunity groups. The n-th state transition opportunity is an n-th opportunity from one of a base state and a target state among one or a plurality of state transition opportunities. The following description applies to each of the one or more n-th individual transition opportunities.
Among one or more individual transition opportunities with respect to a customer corresponding to the opportunity, the n-th individual transition opportunity is an n-th opportunity from one of the base state and the target state.
A feature amount difference group corresponding to the n-th individual transition opportunity is one or more feature amount differences corresponding to the n-th individual transition opportunity.
Each of the one or more feature amount differences is a difference between a feature amount corresponding to one of two time segments and a feature amount corresponding to the other time segment, the two time segments constituting a time segment pair that is the n-th individual transition opportunity.

The n-th state transition opportunity is an opportunity calculated by a factorial analysis of one or more feature amount differences corresponding to one or more n-th individual transition opportunities.

With respect to each customer belonging to the group of focus, the plurality of segments of the customer include one or more time segment sets. With respect to each customer belonging to the group of focus, each of the one or more time segment sets of the customer is constituted by a pertinent time segment that is a time segment in which the determined class 604 (an example of one or a plurality of customer attributes) of the customer includes class conditions (an example of one or more customer attributes) related to the target state and one or more previous time segments that are consecutive to the pertinent time segment. With respect to each customer belonging to the group of focus, regarding each of the one or more time segment sets of the customer, each time segment pair is constituted by two consecutive time segments.

The output information 120 is the integrated transition diagram 2420 which is a transition diagram created by integrating a plurality of transition diagrams respectively corresponding to a plurality of customer groups. Each of the plurality of transition diagrams indicates how the target state is reached from the base state via one or a plurality of state transition opportunities calculated with respect to a group corresponding to the transition diagram. The integrated transition diagram 2420 includes a plurality of nodes including the opportunity node 24 corresponding to a state transition opportunity and a plurality of edges connecting the nodes. In the integrated transition diagram 2420, two or more of the same state transition opportunities respectively calculated with respect to two or more different customer groups are a single node 24A or 24B.

While an embodiment has been described above, the embodiment is merely an example for describing the present invention and is not intended to limit the scope of the present invention thereto. The present invention can be implemented in various other modes. For example, instead of or in addition to the distribution industry or the retail industry, the present invention is also applicable to other fields.

As a first example, the present invention can conceivably be applied to the life insurance sales business. For example, let us assume that there is a life insurance policy “AAA” that is expected to be more profitable on a continuous basis and that a business operator (a life insurance sales business operator) desires to increase the close rate for the policy “AAA”. However, when it is understood that making a direct appeal for the policy “AAA” is inappropriate but the present invention is not applied, the business operator is unable to identify an effective method and timing of contacts that had led to closing sales. When the present invention is applied, for example, consumers (existing policyholders) having bought the policy “AAA” can be distinguished from other consumers and feature amounts are expected to be constructed around time-series contractual information. In addition, what kind of characteristic transition opportunities had existed between making an initial contact to closing a sale of the policy “AAA” can be clarified and the transition opportunities are expected to be expressed by a transition diagram. Using the transition diagram, from a state of a consumer who currently can be contacted, it is expected that an effective opportunity can be found and a measure based on the opportunity can be determined toward closing a sale of the policy “AAA”. In this example, the “target” may be a “consumer”, the “target attribute” may be a “class”, the “segment” may be a “time segment”, and the “management support” may be “sales support”.

As a second example, the present invention can conceivably be applied to the semiconductor manufacturing business. For example, let us assume that a business operator (a semiconductor manufacturing business operator) is manufacturing a product “BBB” and desires to improve a manufacturing yield thereof or, more specifically, increase the number of days of operation of which a daily yield rate is 95% or higher. However, a manufacturing process of the product “BBB” has a large number of steps and, when the present invention is not applied, it is unclear as to how an operation in a given step after starting the manufacturing process affects the yield rate. When the present invention is applied, operations that result in a daily yield rate of the product “BBB” of 95% or higher can be distinguished from other operations and feature amounts are expected to be constructed around process-sequential manufacturing information. In addition, it is expected that what kind of characteristic transition opportunities had existed between the start of the manufacturing process and a manufacturing process at which a yield rate of 95% or higher is reached can be clarified and the transition opportunities can be expressed by a transition diagram. Using the transition diagram, from a state of a current manufacturing process, it is expected that the business operator can find an effective opportunity to increase the yield rate to 95% or higher and determine a measure based on the opportunity. In this example, the “target” may be a “product”, the “target attribute” may be a “class”, the “segment” may be a “segment between steps”, and the “management support” may be “manufacturing process management support”.

What is claimed is:

1. A management support system, comprising:
a transition opportunity calculating portion which performs a transition opportunity calculation process that is a process including calculating one or a plurality of state transition opportunities from a base state to a target state with respect to M-number of targets (where M is a natural number such that M≥2) on the basis of management data including data related to histories of the M-number of targets; and
a processing result output portion which outputs information including information related to the one or a plurality of state transition opportunities calculated in the transition opportunity calculation process.

2. The management support system according to claim 1, wherein
the management data includes time-series feature amount data,
the time-series feature amount data is data having a plurality of data sets which respectively correspond to a plurality of segments in a time series with respect to each of the M-number of targets and which respectively include one or more feature amounts regarding a history of the target,
the transition opportunity calculation process includes,
with respect to each of the M-number of targets, for each segment pair, calculating an alteration degree in accordance with a difference between one or more feature amounts corresponding to one of the segments and one or more feature amounts corresponding to the other segment and identifying the segment pair as an individual transition opportunity when the calculated alteration degree satisfies a prescribed condition, and
when there is an individual transition opportunity group that is one or more individual transition opportunities with respect to at least one of the M-number of targets, calculating the one or more state transition opportunities with respect to the M-number of targets on the basis of one or more individual transition opportunities respectively corresponding to the one or more targets, and
each segment pair is a pair of two consecutive segments.

3. The management support system according to claim 2, wherein
an n-th (where n is a natural number) state transition opportunity is an opportunity on the basis of one or more feature amount difference groups corresponding to one or more n-th individual transition opportunities in the one or more individual transition opportunity groups,
the n-th state transition opportunity is an n-th opportunity from one of the base state and the target state among the one or a plurality of state transition opportunities, and
with respect to each of the one or more n-th individual transition opportunities,
the n-th individual transition opportunity is an n-th opportunity from one of the base state and the target state among one or more individual transition opportunities with respect to a target corresponding to the opportunity,
a feature amount difference group corresponding to the n-th individual transition opportunity is one or more feature amount differences corresponding to the n-th individual transition opportunity, and
each of the one or more feature amount differences is a difference between a feature amount corresponding to one of two segments and a feature amount corresponding to another segment, the two segments constituting a segment pair that is the n-th individual transition opportunity.

4. The management support system according to claim 3, wherein
the n-th state transition opportunity is an opportunity calculated by a factorial analysis of one or more feature amount differences corresponding to the one or more n-th individual transition opportunities.

5. The management support system according to claim 2, further comprising
a grouping portion which classifies each of N-number of targets (where N is a natural number such that N>M) into one or more groups to which the target corresponds in a plurality of groups respectively associated with one or more target attributes, wherein
the M-number of targets are all targets classified into a group of focus that is any group among the plurality of groups.

6. The management support system according to claim 5, wherein
the transition opportunity calculating portion generates the time-series feature amount data on the basis of data related to the history.

7. The management support system according to claim 5, wherein
with respect to each of the M-number of targets, the plurality of segments of the target includes one or more segment sets,
with respect to each of the M-number of targets, each of the one or more segment sets of the target is constituted by a pertinent segment in which one or a plurality of target attributes of the target includes one or more target attributes related to the target state and one or more previous segments that are consecutive to the pertinent segment, and
with respect to each of the M-number of targets, regarding each of the one or more segment sets of the target, each segment pair is constituted by two consecutive segments.

8. The management support system according to claim 5, wherein
the output information is an integrated transition diagram that is a transition diagram created by integrating a plurality of transition diagrams respectively corresponding to the plurality of groups,
each of the plurality of transition diagrams indicates how the target state is reached from the base state via one or a plurality of state transition opportunities calculated with respect to a group corresponding to the transition diagram,
the integrated transition diagram includes a plurality of nodes including an opportunity node corresponding to a state transition opportunity and a plurality of edges connecting the nodes, and
in the integrated transition diagram, two or more of the same state transition opportunities respectively calculated with respect to two or more different groups are a single node.

9. The management support system according to claim 1, wherein
the output information is a transition diagram indicating that, with respect to the M-number of targets, the target state is reached from the base state via the one or a plurality of state transition opportunities.

10. The management support system according to claim 9, further comprising
a grouping portion which classifies each of N-number of targets (where N is a natural number such that N>M) into one or more groups to which the target corresponds in a plurality of groups respectively associated with one or more target attributes, wherein
the M-number of targets are all targets classified into a group of focus that is any group among the plurality of groups,
the output information is an integrated transition diagram that is a transition diagram created by integrating a plurality of transition diagrams respectively corresponding to the plurality of groups,
each of the plurality of transition diagrams indicates how the target state is reached from the base state via one or a plurality of state transition opportunities calculated with respect to a group corresponding to the transition diagram,
the integrated transition diagram includes a plurality of nodes including an opportunity node corresponding to a state transition opportunity and a plurality of edges connecting the nodes, and
in the integrated transition diagram, two or more of the same state transition opportunities respectively calculated with respect to two or more different groups are a single node.

11. The management support system according to claim 1, wherein
the output information includes information indicating, with respect to each of one or more targets, a state of the target which is identified on the basis of the management data, and a state transition opportunity which is a single opportunity among the one or a plurality of state transition opportunities and which is an opportunity for making a transition from the state to a next state.

12. The management support system according to claim 1, wherein
each of the M-number of targets is a target that has previously reached the target state.

13. The management support system according to claim 10, wherein
the plurality of groups are respectively associated with a plurality of target attributes respectively corresponding to a plurality of element units constituting the target state.

14. A management support method, comprising the steps of:
performing a transition opportunity calculation process that is a process including calculating one or a plurality of state transition opportunities from a base state to a target state with respect to M-number of targets (where M is a natural number such that M≥2) on the basis of management data including data related to histories of the M-number of targets, and
outputting output information including information related to the one or a plurality of state transition opportunities calculated in the transition opportunity calculation process.

15. A computer program causing a computer to execute the steps of:
performing a transition opportunity calculation process that is a process including calculating one or a plurality of state transition opportunities from a base state to a target state with respect to M-number of targets (where M is a natural number such that M≥2) on the basis of management data including data related to histories of the M-number of targets, and
outputting output information including information related to the one or a plurality of state transition opportunities calculated in the transition opportunity calculation process.
